(19) United States
(12) Patent Application Publication
(10) Pub. No.: US 2017/0263143 A1
(43) Pub. Date: Sep. 14, 2017

(54) SYSTEM AND METHOD FOR CONTENT ENRICHMENT AND FOR TEACHING READING AND ENABLING COMPREHENSION

(71) Applicant: Vizread LLC, Saratoga, CA (US)

(72) Inventor: Venkat Venkataratnam, Saratoga, CA (US)

(21) Appl. No.: 15/453,514

(22) Filed: Mar. 8, 2017

Related U.S. Application Data
(60) Provisional application No. 62/305,258, filed on Mar. 8, 2016.

(51) Int. Cl. G09B 17/00; G09B 7/08; G06F 17/22; G09B 5/06; G06F 17/27; G06F 3/0482

(52) U.S. Cl. CPC G09B 17/006; G06F 17/2705; G06F 3/0482; G06F 17/2235; G06F 17/274; G09B 5/065; G09B 7/08

(57) ABSTRACT

A method of enriching text includes receiving a text file and parsing the received text file into logical phrases each having a phrase type. The logical phrases are processed based on their respective phrase types. A first processing step determines whether to process each logical phrase as a whole or in parts, and further identifies, splits or combines phrases according to pre-defined logic to determine a contextual meaning for each logical phrase. Additional processing steps determine a contextual part of speech for each word in the logical phrases and identify enrichment content pertaining to each of the words and the logical phrases. The words and logical phrases are associated and stored with the enrichment content respectively pertaining thereto such that the enrichment content is renderable on a user computing device when the word or logical phrase associated therewith is selected by a user on the user computing device.

### CROSS REFERENCE TO RELATED APPLICATION

This application claims the benefit of U.S. Provisional Patent Application Ser. No. 62/305,258, filed Mar. 8, 2016, entitled “SYSTEM AND METHOD FOR CONTENT ENRICHMENT AND FOR TEACHING READING AND ENABLING COMPREHENSION,” which is incorporated herein by reference in its entirety.

### FIELD

The invention relates to the field of content enrichment and assistive reading.

### BACKGROUND

Computer assisted reading technologies have revolutionized how children are taught to read. However, the same tend to be limited to only speaking words out loud or providing a definition. Moreover, the same are deficient at providing a fuller experience for the reader, so as to better achieve understanding and comprehension of words and phrases in context. These children could be children with learning disabilities, children without learning disabilities or children belonging to countries where English is not the main language spoken.

Children often have one or more of the following challenges while reading:
Comprehending a word or phrase
Pronouncing a word or phrase
Visualizing or imagining what a word, subject, object or phrase means
Hearing out loud what a particular sound or audio really sounds like

For instance, comprehension is a big challenge for children. A good reader does not necessarily comprehend everything that he/she is reading. Parents and teachers assume children are able to comprehend whatever they read. It is quite possible, however, that a good portion of what is being or has been read is not understood well. During the activity of reading, children may have to regularly perform various tasks in order improve their comprehension. This may require them to search a dictionary or ask a parent, guardian or teacher to provide the meaning of a word or phrase or to provide the correct pronunciation of a word. Likewise, the child may need help with visualizing a word or phrase and may resort to searching an image repository or having someone search an image repository for them. In addition, the child may need help in understanding what a certain action or activity looks like, means or sounds like.

All of the above tasks interrupt a child's main activity, which is reading and can cause fatigue, leading to the child losing interest. A considerable amount of time may also lost or spent performing these other tasks. Additionally, another important challenge is that a parent or guardian may not have the wherewithal, knowledge or time to help the reader.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

Systems and methods according to present principles can meet the needs noted above in several ways. In particular, systems and methods according to present principles provide convenient ways to assist the reader in obtaining information about text and phrases that they are reading and as they are reading and without having to leave or significantly disrupt his/her reading activity. The systems and methods, in certain implementations, provide such information using multimedia techniques that can be highly interesting and engaging for users.

Advantages of the invention may include, in certain embodiments, one or more of the following: Children and other users learning to read may be provided with a significantly richer learning experience, increasing speed of reading, learning, increasing comprehension, enhancing enjoyment of the same and making reading less arduous; Make children independent readers and learners; Provide a one-stop place to learn main aspects of a word or phrase without having to leave the reading activity. The invention may be especially useful to a child whose parent or guardian lacks the time, knowledge or wherewithal to assist the child, thus attempting to level the playing field for all early readers.

Other advantages will be understood from the description that follows, including the figures and claims.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

### BRIEF DESCRIPTION OF THE DRAWING

FIG. 1 is a schematic block diagram showing one example of an environment in which aspects of the systems and methods described herein may be implemented.

FIG. 2 illustrates an exemplary flow of the method according to present principles.

FIG. 3 illustrates an implementation of an enrichment engine according to present principles.

FIG. 4 shows an example architecture for a device such as the user computing devices or servers shown in FIG. 1 which are capable of executing the various components described herein for implementing aspects of the content enrichment techniques described herein.

### DETAILED DESCRIPTION

### General

In particular, systems and methods according to present principles provide a multi-modal and multi-sensory learning experience, e.g., to children in grades 1 through 6, or for other users learning to read in either their native language or a second language. To that extent, a user application (“app”) may provide, in certain implementations, the following functionality:
1. Provide licensed or home-grown passages (content) that have been enriched with metadata such as a word or phrase definition, pronunciation, images, audio, animation and videos. The users will then have the option of downloading one or more of these enriched passages (content) onto their computing devices, bookmarking them or just leaving them on the server.
2. The user can start reading an enriched passage using the app or by using a browser on their computer by downloading the passage onto their computing device or by even not downloading the same.
3. Provide users the ability to create their own content or upload a document (PDF, Word, Pages, text etc.) from their computing device or from an external content repository using the app or a web server and request the app or the web server to enrich the content for them. The app or the web server will consume the content, enrich it using the enrichment engine and send it back to the user/to their device or computer. User created or uploaded documents and corresponding enriched content need not be stored on the content enrichment servers, although such is a possibility.
4. Provide the ability to create and manage different categories of users including parents, guardians, teachers and students/children and additionally provide the ability for them to form relationships among themselves within the application and collaborate to support reading and comprehension activities of the children.

### Operating Environment

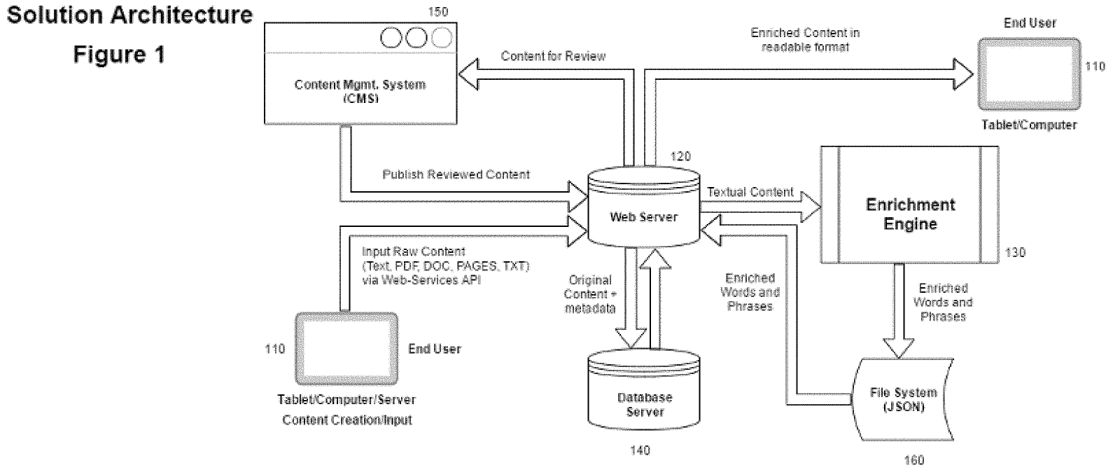

FIG. 1 is a schematic block diagram showing one example of an environment in which aspects of the systems and methods described herein may be implemented. The environment 100 includes computing devices 110 that are employed by end users to create, retrieve and interact with the enriched content, either through a dedicated app located on the computing device or through a web browser. Examples of suitable computing devices 110 that may be employed include, without limitation, a smartphone, personal computer (desktop, laptop, notebook), tablet computer and so on. While only two computing devices 110 are shown in FIG. 1, more generally any number of computing devices may be used to create, retrieve and interact with the enriched content.

Computing devices 110 may communicate with a server 120 such as a web server over one or more communication networks such as the Internet and/or one or more intranets, a local-area network, a wide-area network, a landline or wireless network, or any combination thereof. The web server 120, in turn, communicates with an enrichment engine 130 and a database server 140. The original content along with any associated formatting is saved in the database server 140. Original content could either be uploaded or manually created.

Additionally, metadata relating to the content including, for instance, the designated grade levels for which the content is deemed suitable and the subject matter to which the content pertains will also be entered and stored along with the original content in the database 140. The web server 120 retrieves raw textual content that contains no formatting from the database 140 and passes it to the enrichment engine 130. The enrichment engine 130 processes this raw text that is to be enriched and obtains all the enrichment metadata that is to associated with the various phrases and words in the text. The manner in which the enrichment engine 130 performs these tasks will be discussed in more detail below. Once the enriched words and phrases and their associated enrichment metadata have been created by the enrichment engine 130 they may be stored in a file system 160 as a JavaScript Object Notation (JSON) file such as represented in FIG. 1.

It should be noted that the functionality of the web server 120, enrichment engine 130, file system 160 and database server 140 may be integrated into a single server or distributed over any number of devices in a server complex or other distributed computing environment.

The illustrative environment 100 shown in FIG. 1 also includes a content management system 150. Content management system 150 allows content creators and content reviewers including those providing the content, a parent, teacher or other responsible individual to review the enriched content provided by the enrichment engine for accuracy, correctness and relevance and make appropriate changes before exposing the enriched content to a child or student or any other type of user including parents, guardians and teachers. That is, a human curator can manually review, edit and further enhance the enriched content. In this way the responsible individual can tailor the enriched content for a particular user or audience. For instance, the responsible individual may wish to enrich the content themselves by adding content that is more suitable for a particular age group than is otherwise available from the enriched content stored on the database server 140 and file system 160. The content management system 150 may provide any suitable user interface that allows the additional content to be added by any suitable means, such as by cutting and pasting content, directly typing in content, uploading documents and other content objects from an outside source or content repository, and so on.

In some embodiments the functionality of the content management system 150 may reside in whole or in part in the app or the web server. Alternatively, the functionality of the content management system 150 may be distributed between the app and the web server. In either case, in some implementations the content management system 150 may provide recommendations to the content creator or reviewer, a parent or a teacher as he or she is making changes to the content. The content creator or reviewer, parent or teacher may accept any of the recommendations or simply make their own changes to the enriched content.

In operation, enriched words and phrases along with their associated metadata that is stored in file system 160 are merged with the original content that is stored in the database server 140 to form the enriched content and may be accessed by the end users on computing devices 110 via web server 120. If the content that is to be enriched is provided by the user, it can be submitted by the computing device 110 to the enrichment engine 130 via the web server 120 using a content entry mechanism that can be provided either by the app on the communication device or by the web server 120.

The computing devices 110 (via the app) and the web server 120 thus provide a way for users to choose grade-specific enriched passages and download the same onto to their computing device within the app if they so choose. They may also choose to leave the content on the database server 140 and file system 160. The app and/or the web server 120 may provide a “reader” tool that enables the users to make use of the enriched content, read the content, listen to the pronunciation of a word, view images for words or phrases, view video clips, hear audio clips and view animations for words or phrases. As a user is reading a passage, the app and the web server may also provide the user with the ability to select any text within a passage and have the selected text read aloud. This feature may be configured using licensed text to speech software. Additionally, in some embodiments as the user progresses through the enriched content he or she may be prompted with questions (that may be automatically generated by the app) that need to be answered, so as to confirm their comprehension. Questions and multiple-choice answers for the user to select from may be generated using the enrichment metadata associated with the content.

In some embodiments, an additional features offered by the application is the ability to create and manage different categories of users including parents, guardians, teachers and students/children and to enable collaboration among them to further the children's reading and comprehension activities. Different users may create and manage their own user accounts and profiles. They may also collaborate among themselves by establishing relationships in a secure manner, extending invitations to other users within the application and accepting or rejecting those invitations. For example: a parent user, apart from setting himself/herself up in the application as recognized users of the enriched text, may extend invitations to his/her children to connect in the application. Users may establish themselves as recognized users in any of a variety of ways including, for instance, establishing a user account through the application or website. They may also add their children as recognized users in the application. Similarly, a parent can set up accounts or profiles for guardians of their children and extend invitations to them through the application. A teacher, may also set up accounts for entire classes of students and for each class, set up one or more of his/her students as recognized users by extending invitations to them or by adding them through the application. A parent or guardian may also extend an invitation to a teacher to become a recognized user through the account or profile one of their children. A teacher may also do the same to parents and guardians. When invitations are exchanged, each user may be able to accept or reject invitations and view the status of the sent or received invitations. At any point of time, a user also may be able to identify all the other recognized users that he or she is linked to and the profiles of each such user. A user may also be able to delete his/her link relationship with another user. Also, parents will be able to identify all the relationships that their children are maintaining with respect to the app.

The enriched content made available by the environment 100 shown in FIG. 1 may provide end users with a wide variety of features and functions, several of which are illustrated below by way of example. It should be noted that in any given implementation, not all of these features are required. The features include:
1. Enablement of a multi-sensory and multi-modal way of reading by providing, meaning/definitions, pronunciations, images, videos, audio/sounds and/or animation in one place and on-demand on a computing device or through a web browser or the like.
2. A method for displaying images on-demand for logical chunks of text (e.g., phrases) to make the chunks or the individual words in the chunks more relevant within their larger context.
3. A method for rendering video and animation for a given word or logical phrase on-demand. For example, if the user comes across the text “Once he was asked to, he leapt to get the book off the top of the book shelf,” a video or animation of an individual performing this act of leaping may be presented.
4. A method for rendering audio or sound bites for a given word or logical phrase on-demand. For example, if the user comes across the text “The birds chirped,” a user may be presented with the sound of birds chirping.
5. A method that enables an end user to provide content to the enrichment engine, which then consumes the content, processes it and returns the enriched content back to the user.

Thus, in summary, in one implementation, a method according to present principles provides for displaying images, playing video and sound and showing animation for phrases or for individual words within sentences to make the words and phrases more relevant.

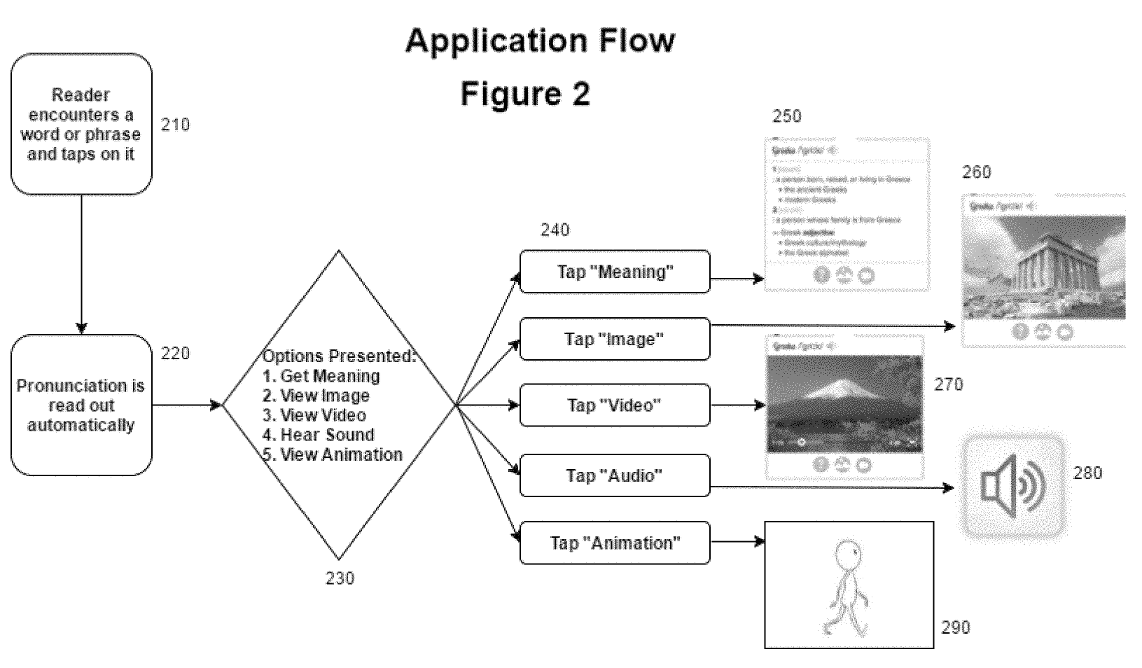

FIG. 2 is a flowchart showing one example of method that may be performed as a user is reading the enriched content on a computing device in which some of the above-mentioned features may be accessed. At block 210 the user encounters a word or phrase and selects it any suitable manner. For instance, if the user is reading the text on a computing device equipped with a touch screen, the user may tap the word or phrase in order to select it.

Alternatively, the user may select the work or phrase by highlighting it using a cursor controlled by a user input device such as a mouse. More generally, the user may select the word or phrase in any convenient manner that will be largely dictated by the functionality offered by the computing device on which the enriched content is being rendered. Next, in an optional step 220 the selected word or phrase may be automatically read out loud so that the user can be given the correct pronunciation. In some embodiments this optional feature, as well as other features and functions described herein, may be automatically provided in accordance with user-selectable settings that can be established through the app and/or web browser. For instance, the user may decide that the automatic pronunciation feature may be normally enabled or disabled in accordance with their personal preference.

The method shown in FIG. 2 then proceeds to block 230 in which the user is presented with more options in response to the selection of the word or phrase. For instance, examples of such options include, without limitation, get meaning, view image, view video, hear sound and view animation. As FIG. 2 further illustrates, by selecting any of these options (by e.g., tapping one the selection on a touch screen) at block 240, the corresponding meaning 250, image 260, video 270, audio 280 or animation 290 will be rendered. The user-selectable options, as well as the metadata itself, may be presented in any convenient format. For instance, they may be presented on the display of the computing device as a pop-up adjacent to the word or phrase with which it is associated. Alternatively, they may be presented in a separate window or in any other suitable manner. Upon viewing or hearing an enrichment for a given word or phrase, the end user may have the ability to provide feedback concerning the enrichment via an online form.

### Enrichment Engine

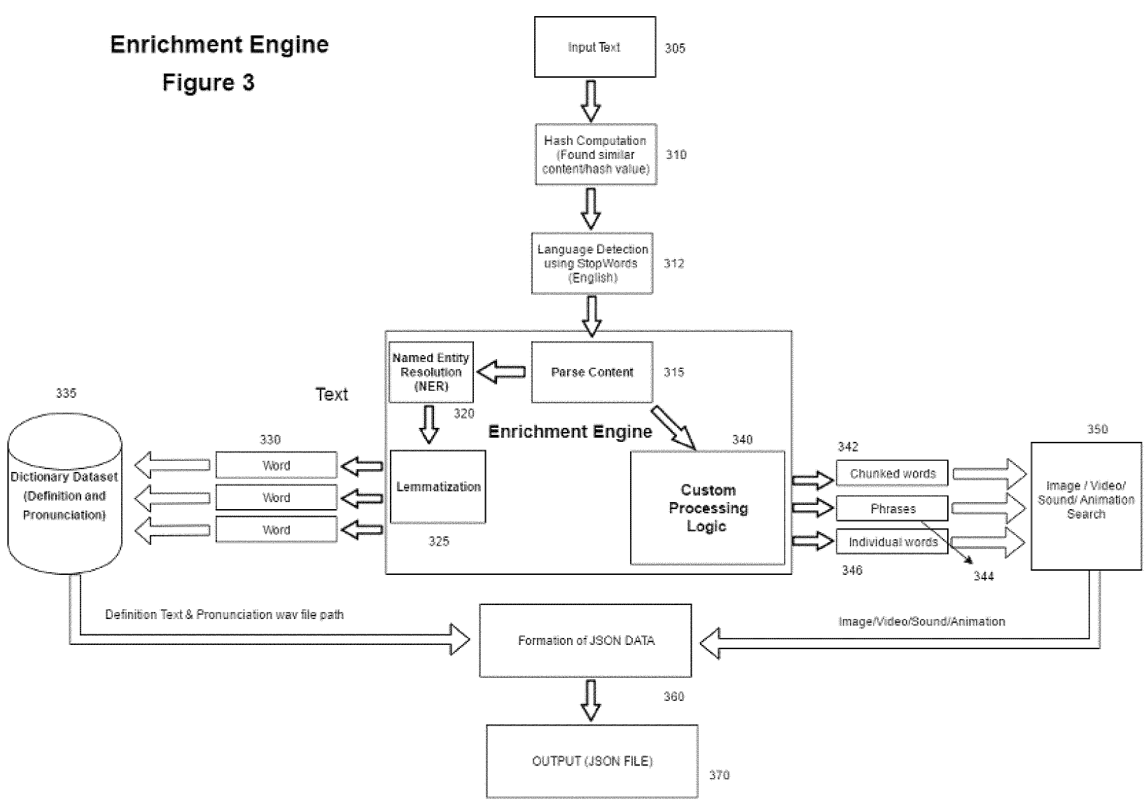

FIG. 3 shows a functional block diagram of one example of the enrichment engine 130. As such, those of ordinary skill will recognize that alternative embodiments may employ more or less functionality/modules as necessitated by the particular scenario and/or architectural requirements and that various functions may be distributed among devices or modules in a different manner than may be suggested in FIG. 3.

At block 305 the text that is to be enriched is input to the engine 130 when it is passed as a parameter by the web server 120. Then, at block 310 a hash function is used to determine if the text has already been parsed by locating the corresponding file with the same hash value in the database server 140.

If the text has not yet been enriched it is passed to block 312 where various stop words, which are common words that do not need to be enriched, are ignored or denoted as not necessary for processing. The text is then passed to blocks 315 and 320 where it undergoes named entity recognition, first by parsing the text (block 315) and then performing named entity resolution (NER) (block 320). First, at block 315 the text is parsed by identifying individual sentences and words and the Part of Speech (POS) for each word in the context in which it is being utilized. Logical phrases are also identified within each sentence and, in some cases, certain phrases may be combined using the custom logic described below to further make the phrases relevant, contextual and logical.

Once the text is parsed, NER is used at block 320 to locate and classify named entities in the text into pre-defined categories such as the names of persons, organizations, locations, expressions of times, quantities, monetary values, percentages, etc. Any of a variety of different software packages are available for performing NER. For example, if the language of the text is English, then in one implementation the Stanford Named Entity Recognizer may be used, which is an open source Java library for named entity recognition. That is, the Stanford NER can extract named entities out of a given text.

Next, at block 325 lemmatization is performed to identity the lemma for each named entity based on its intended part of speech using, e.g., the Stanford Parser. The resulting words 330 are then sent to a suitable dictionary at block 335 to determine the definition and pronunciation (path to the pronunciation file) for each word. For example, in one implementation the Cambridge XML Dictionary Dataset may be used.

Returning to block 315 where the text is initially parsed, the text is then passed to block 340 where custom logic processing is used to identify certain chunked words 342, phrases 344 and individual words 346 that are then passed to a routine 350 to retrieve suitable image, video and/or audio URLs. For example, in one implementation, the Microsoft Cognitive Services Bing Image Search API and Bing Video Search API may be used to retrieve the relevant URLs. Similarly, APIs available from Freesound.org, for instance, may be used to retrieve sound URLs. Of course, alternative search retrieval databases and services may be used instead. In some cases only a single URL may be retrieved for each data type (e.g., image, video, audio). In other cases multiple URLs may be retrieved, possibly with one being designated a primary URL and the others being designated secondary URLs.

Next, at block 360, chunked words 342, phrases 344 and individual words 346, the output from the calls to the routine 350 for image, video and/or audio APIs and the output from the calls to the dictionary dataset 335 are merged in a suitable data format such as the JavaScript Object Notation (JSON) data format, for example. Of course, other suitable formats such as XML may be used as well. The resulting data file with the enriched words and phrases and associated metadata is then output at block 370 for transmission to the web server 120 and the file system 160. If the text that is being enriched has been provided by the user, the data file 360 with the enriched content need not necessarily be stored by the system in the database server 140 and file system 160 but rather may just be sent back to the user's computing device by the web server 120.

The custom processing logic employed at block 340 will now be described in more detail. As part of the parsing process performed at block 315 different types of English language phrases are identified. The phrase types include Noun Phrases, Verb Phrases, Prepositional Phrases, Adjective Phrases and Adverb Phrases. A given sentence is made up of one or more of these phrases, which can also be nested. When a sentence is processed, the different phrases (along with their types) that make up the sentence, including any and all nested phrases and nesting rules, Part of Speech (verb, noun, preposition, conjunction, adverb, adjective etc.) of each of the words in the sentence as well as Parts of Speech that are not present, and punctuations are identified. Once this information has been obtained, the custom logic is then used to process the phrases and one or more of the following actions, which could be recursive, are performed on them:
1. Process the parent and child/subordinate phrases separately if it is a nested phrase;
2. Process the phrase (parent or child) as a whole;
3. Break-up the phrase into even smaller phrases;
4. Break-up the phrase into individual words that make it up.

For each phrase identified above, as well as for certain individual words (depending on its Part of Speech), the API calls discussed above are made to retrieve image, video, audio and/or animation URLs from the respective content repositories. An example of how a phrase may be processed before making the API call is shown below for a noun phrase. Other types of phrases may be processed in a similar manner.

### Example Algorithmic Custom Logic:

### Legend:

### Phrase Types:

NP—Noun Phrase
PP—Prepositional Phrase
ADJP—Adjective Phrase

### Parts of Speech:

PRP—pronoun, personal (e.g., hers, herself, him, himself, it, itself, me, myself, one, oneself, ours, ourselves, self, she, thee, theirs, them, themselves, they, thou, thy, us)
PRP$—pronoun, possessive (e.g., her, his, mine, my, our, ours, their, thy, your)
DT—determiners (e.g., them, these, this, those)
RB—adverb
RBR—adverb, determiner
RBS—adverb, superlative
CC—conjunction, coordinating

Following is the logic for processing Noun Phrases (NPs):

1. If the NP has a comma

Extract all chunks from this NP

If chunk doesn't have a comma, process as is to obtain enriched data

If chunk has comma(s), separate the words in comma

2. If the NP has a subordinate clause

Remove the subordinate clause from the NP

Process the NP as is to obtain enriched data

Process the subordinate clause as is to obtain enriched data

3. If the NP's first word is an ADJP

Process it as it as is to obtain enriched data

4. If the NP has comma(s) and a conjunction

Split the phrase around the conjunction

If the sub-phrases are identified as a PERSON, take the phrase as a whole

Else

If the sub-phrases have comma(s)
Split the sub-phrase around comma
Check if the first and last words are numeral
If so strip the numerals
Else take the words

Else take the words

5. If the NP has commas

Split the phrase around commas

Check if the sub-phrases are identified as a LOCATION

If so take the phrase as a whole

Else take the sub-phrases

6. If the NP has a conjunction, follow rule 4 above
7. If the NP has no commas or conjunctions, take the phrase as is
8. If the NP has an NP and PP and a conjunction is not part of the phrase

Apply rules 4, 5, 6, 7 above

9. If the NP has an NP, Conjunction and an NP, in that order

Traverse the NP to find words that are before and after the conjunction

For the phrase in the previous step, apply rules 5, 6 above

In all these steps, perform the following:

1. Remove punctuations before and after the phrase
2. Remove specific words that have the following Parts of Speech [‘PRP’, ‘PRP$’, ‘DT’, ‘RB’, ‘RBR’, ‘RBS’, ‘CC’]

As mentioned above, other phrase types may be analyzed in a similar manner prior to searching for enriched data that can be associated with each phrase.

### Content Scrubbing

After the enriched content has been generated, any content that is subject to copyright or otherwise owned or licensed may undergo a “content scrubbing” process which is provided as a service before exposing the enriched content to the user. This step may or may not be applicable to content that is created by a user or to document(s) that are uploaded by a user. As part of this process a content publisher may review and edit the enriched content for accuracy, relevance and applicability, including deciding if any primary and secondary URLs and the like should be included and make any changes to the enrichment recommendations made by the enrichment engine for images, videos, sound and animation. One or more enrichment types (definition, pronunciation, image, video, sound, animation) may also be removed for one or more phrases or words, or entire words or phrases can be stripped of all enrichment. New enrichments may also be manually added to one or more words or phrases. New enrichments may also be manually added to one or more words or phrases. Once the content publisher has approved the enriched content, it can be stored on the database server 140 and file system 160 designated as being suitable for one or more grade levels so that users have the ability to download the enriched passage on to their computing devices. In some embodiments this content scrubbing process may be performed using the content management system described above or some alternative system.

For content that is created by a responsible end user or obtained from document(s) that are uploaded by such user, “content scrubbing” can also be performed by using the app and utilizing the tools that may be provided within the app. Responsible end users are typically a parent, guardian or teacher. Here again, the responsible end user, may perform all of the content scrubbing activities, including being able to review and edit the enriched content for accuracy, relevance and applicability, including deciding if any primary and secondary URLs and the like should be included and make any changes to the enrichment recommendations made by the enrichment engine for images, videos, sound and animation. One or more enrichment types (definition, pronunciation, image, video, sound, animation) may also be removed for one or more phrases or words, or entire words or phrases can be stripped of all enrichment. New enrichments may also be manually added to one or more words or phrases. Once a responsible end user completes the content scrubbing process, the enriched content may be made available to other individual users on the device or a group they belong to via the web server and the app.

As part of the content scrubbing process, the content publisher or the responsible end user creating content may be able to further define certain words with parts of speech like determiners, personal pronouns, and possessive pronouns. In this way a user or reader of the content can be informed as to what these words with their parts of speech refer to within the context of the text or content.

Depending on the size of the enriched content and the manner in which it is displayed, windows that pop up or appear for a particular word or phrase may be appropriately sized and repositioned, such that appertaining images fit into each defined window. In some cases, the windows may be scrollable. In many cases, image resolution will not be changed, so that the clarity of the image is maintained.

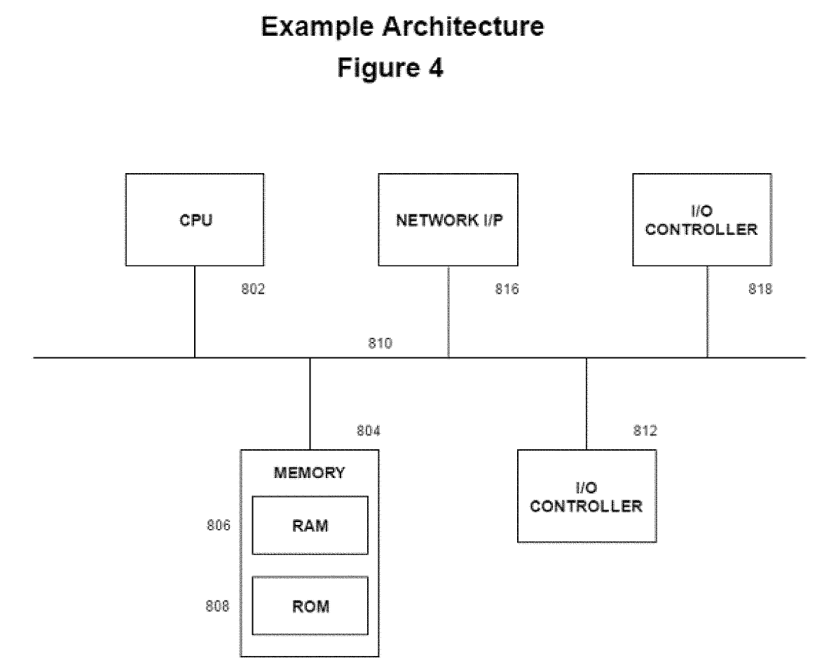

FIG. 4 shows an example architecture 800 for a device such as the user computing devices or servers shown in FIG. 1 which are capable of executing the various components described herein for implementing aspects of the content enrichment techniques described herein. Thus, the architecture 800 illustrated in FIG. 4 shows an architecture that may be adapted for a server computer, mobile phone, a PDA, a smartphone, a desktop computer, a netbook computer, a tablet computer, GPS device, gaming console, and/or a laptop computer. The architecture 800 may be utilized to execute any aspect of the components presented herein.

The architecture 800 illustrated in FIG. 4 includes a CPU (Central Processing Unit) 802, a system memory 804, including a RAM 806 and a ROM 808, and a system bus 810 that couples the memory 804 to the CPU 802. A basic input/output system containing the basic routines that help to transfer information between elements within the architecture 800, such as during startup, is stored in the ROM 808. The architecture 800 further includes a mass storage device 812 for storing software code or other computer-executed code that is utilized to implement applications, the file system, and the operating system.

The mass storage device 812 is connected to the CPU 802 through a mass storage controller (not shown) connected to the bus 810. The mass storage device 812 and its associated computer-readable storage media provide non-volatile storage for the architecture 800.

Although the description of computer-readable storage media contained herein refers to a mass storage device, such as a hard disk or CD-ROM drive, it should be appreciated by those skilled in the art that computer-readable storage media can be any available storage media that can be accessed by the architecture 800.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), Blu-ray, or other optical storage, magnetic cassettes, magnetic tape, magnetic disk storage or other magnetic storage devices, or any other medium which can be used to store the desired information and which can be accessed by the architecture 800.

According to various embodiments, the architecture 800 may operate in a networked environment using logical connections to remote computers through a network. The architecture 800 may connect to the network through a network interface unit 816 connected to the bus 810. It should be appreciated that the network interface unit 816 also may be utilized to connect to other types of networks and remote computer systems. The architecture 800 also may include an input/output controller 818 for receiving and processing input from a number of other devices, including a keyboard, mouse, or electronic stylus (not shown in FIG. 8). Similarly, the input/output controller 818 may provide output to a display screen, a printer, or other type of output device (also not shown in FIG. 8).

It should be appreciated that the software components described herein may, when loaded into the CPU 802 and executed, transform the CPU 802 and the overall architecture 800 from a general-purpose computing system into a special-purpose computing system customized to facilitate the functionality presented herein. The CPU 802 may be constructed from any number of transistors or other discrete circuit elements, which may individually or collectively assume any number of states. More specifically, the CPU 802 may operate as a finite-state machine, in response to executable instructions contained within the software modules disclosed herein. These computer-executable instructions may transform the CPU 802 by specifying how the CPU 802 transitions between states, thereby transforming the transistors or other discrete hardware elements constituting the CPU 802.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the architecture 800 in order to store and execute the software components presented herein. It also should be appreciated that the architecture 800 may include other types of computing devices, including handheld computers, embedded computer systems, smartphones, PDAs, and other types of computing devices known to those skilled in the art. It is also contemplated that the architecture 800 may not include all of the components shown in FIG. 4, may include other components that are not explicitly shown in FIG. 4, or may utilize an architecture completely different from that shown in FIG. 4.

In one particular embodiment, the content management system may be implemented using the following technology stack:
Apache 2.0 Web server
PHP 5+ Library
MYSQL 5+ Library
HTML5
CSS3
JAVASCRIPT
WordPress Software

Likewise, in one particular embodiment in which the computing device is an iPad, the computing device may use the following technology stack:
Apache 2.0 Web server
PHP 5+ Library
MYSQL 5+ Library
HTML5
CSS3
JAVASCRIPT
WordPress Software

Finally, the various the functions described herein for implementing aspects of the content enrichment techniques may be written in the Python Programming Language and may use the following Python Libraries:
nitk-3.0.4: Natural language processing
numpy-1.9.2: Multi-dimensional container processing
httplib2-0.9.1: HTTP requests processing
oauth2client-1.5.1: OAuth2 client resource processing for authentication
pyasn1-0.1.8: Data processing for transport between networks
pyasn1-modules-0.0.7: ASN.1 protocol based module
rsa-3.2: Key generation, signing and signature verification
simplejson-3.8.0: JSON representation of data
six-1.9.0: Python compatibility library for Google image search
uritemplate-0.6: URI processing
requests-2.8.1: REST request processing

1. A method of enriching text, comprising:
a. receiving, by an enrichment engine, a text file;
b. parsing, by the enrichment engine, the received text file into one or more logical phrases, the logical phrases each having one of a plurality of phrase types, each of the logical phrases including one or more words of text in the text file;
c. performing, with the enrichment engine, a series of processing steps to process one or more of the logical phrases based on its phrase type determined in the parsing step, the processing steps including:
i. a first processing step including determining whether to process each of the logical phrases as a whole or in parts, and further identifying, splitting or combining phrases according to pre-defined logic to determine a contextual meaning for each of the logical phrases in context;
ii. a second processing step of determining a contextual part of speech for each word in the logical phrases; and
iii. a third processing step including identifying enrichment content pertaining to each of the words and each of the logical phrases;
d. associating and storing each of the words and logical phrases with the enrichment content pertaining to the respective words and logical phrases such that the enrichment content is renderable on a user computing device when the word or logical phrase associated therewith is selected by a user on the user computing device.

2. The method of claim 1, wherein identifying enrichment content includes identifying links to enrichment content or retrieving enrichment content.

3. The method of claim 2, wherein the enrichment content includes image files, audio files, animations, audiovisual files, and/or multimedia files.

4. The method of claim 3, wherein the links to the enrichment content includes a primary URL and one or more secondary URLs for images, audio, animation, audiovisual and/or multimedia content.

5. The method of claim 1, wherein the plurality of phrase types includes types selected from the group consisting of: nounal, verbal, prepositional, adjectival, and adverbial.

6. The method of claim 1, wherein the processing identifies the logical phrase as pertaining to an object, an animal, a plant, or a person, and wherein the enrichment content includes content related to the object, animal, plant, or person.

7. The method of claim 1, wherein the processing identifies the logical phrase as pertaining to a location, and wherein the enrichment content includes content related to the location.

8. The method of claim 1, further comprising displaying the text and the enrichment content for review, editing and confirmation for publishing by an administrative user or an end user so that the text and the enrichment content is able to be edited and/or revised before it is exposed to the end user.

9. The method of claim 8, wherein substantially all of the enrichment content is displayed at one time.

10. The method of claim 1, wherein the enrichment content is associated with the logical phrase by an embedded hyperlink.

11. The method of claim 1, wherein displaying the enrichment content includes providing a menu of user selectable options of enrichment content types.

12. The method of claim 11, further comprising receiving a selection of one of the enrichment content types from among the menu of options, and displaying the enrichment content based on the option type that is selected.

13. The method of claim 11, wherein the menu of options includes one or more of the enrichment content types selected from the group consisting of: definition, meaning, image, animation, read aloud pronunciation, audio and video.

14. The method of claim 1, wherein if the logical phrase is processed in parts, then processing the phrase by one of the steps below:
a. if the logical phrase is a nested phrase, then processing parent and child phrases separately;
b. dividing the logical phrase into smaller phrases and processing the smaller phrases separately; or
c. dividing the logical phrase into individual words and processing the individual words individually.

15. The method of claim 1, further comprising a manual step of an administrative user or end user defining one or more determiners, personal pronouns, and possessive pronouns within the received text, whereby a user may be informed as to what these parts of speech refer to within a context of the text.

16. A non-transitory computer readable medium, comprising instructions for causing a computing environment to perform the method of claim 1.

17. The method of claim 1, wherein the enrichment content includes questions that are automatically and dynamically generated and presented to the user to thereby ensure comprehension of the text by the user.

18. The method of claim 17, wherein the questions include multiple choice answers that are user-selectable.

19. The method of claim 1, further comprising receiving user feedback concerning at least some of the enrichment content.

20. The method of claim 1, further comprising establishing specified individuals as recognized users of the enriched text.

21. The method of claim 20, wherein establishing the specified individuals as recognized users includes establishing user accounts for the specified individuals.

22. The method claim 21, wherein the specified individuals are able to extend invitations to other individuals inviting them to establish user accounts to thereby become recognized users of the enriched text.

23. The method claim 21, wherein the specified individuals are able to view other specified individuals who are recognized users of the enriched text.

24. The method of claim 1, further comprising displaying the text and the enrichment content and allowing an administrator to manually add additional enrichment content.
